(19) United States
(12) Patent Application Publication
(10) Pub. No.: US 2018/0225613 A1
(43) Pub. Date: Aug. 9, 2018

(54) Data-driven Urban Interventions Based on Crowdsourcing

(71) Applicant: International Business Machines Corporation, Armonk, NY (US)

(72) Inventors: Carlos H. Cardonha, Sao Paulo (BR); Bernardo N. Goncalves, Sao Paulo (BR); Jorge L. Guevara Diaz, Sao Paulo (BR); Marisa A. Vasconcelos, Sao Paulo (BR)

(73) Assignee: International Business Machines Corporation, Armonk, NY (US)

(21) Appl. No.: 15/424,870

(22) Filed: Feb. 5, 2017

(51) Int. Cl. G06Q 10/06; G06Q 50/00; G06Q 50/26

(52) U.S. Cl. CPC G06Q 10/06375; G06Q 50/26; G06Q 50/01

(57) ABSTRACT

An embodiment of the invention provides a method for data-driven urban interventions based on crowdsourcing. Images of buildings and a request for feedback to the images are sent to individuals with a communications device. Citizen feedback is received from the individuals with the communications device, where the citizen feedback includes a compatibility score indicating an aesthetical harmony between at least two buildings in the images and a building suggestion. The citizen feedback is stored in an electronic database. Building scores for candidate building interventions are generated with a processor based on the citizen feedback and costs of the candidate building interventions. Each candidate building intervention includes a building style and a building cost. The generating of the building scores includes generating a compatibility score for a candidate building intervention.

### FIELD OF THE INVENTION

The present invention relates to systems, methods, and computer program products for data-driven urban interventions based on crowdsourcing.

### BACKGROUND

Many cities and municipalities do not follow strict and uniform urban planning. Some cities combine different architectural styles in a small area, often placing buildings with highly contrasting styles right next to each other or within the same block. For instance, a modern state-of-the-art building with glass exterior walls and curved edges may be built next to a classic building having stone walls and hard straight edges. Contrasting urban planning not only creates different sensations to people in terms of aesthetics but may also have psychological effects in the citizens of that city.

### SUMMARY OF THE INVENTION

An embodiment of the invention provides a method for data-driven urban interventions based on crowdsourcing. Images of buildings and a request for feedback to the images are sent to individuals with a communications device. Citizen feedback is received from the individuals with the communications device, where the citizen feedback includes a compatibility score indicating an aesthetical harmony between at least two buildings in the images and a building suggestion. The citizen feedback is stored in an electronic database. Building scores for candidate building interventions are generated with a processor based on the citizen feedback and costs of the candidate building interventions. Each candidate building intervention includes a building style and a building cost. The generating of the building scores includes generating a compatibility score for a candidate building intervention.

The generating of the compatibility score for the candidate building intervention includes identifying the building style of the candidate building intervention, identifying the proposed building location of the candidate building intervention, identifying one or more buildings within a threshold distance to the proposed building location, identifying the building style(s) of the building(s) within the threshold distance to the proposed building location, and analyzing the electronic database to determine the average compatibility scores given to the combination of buildings having the building style of the candidate building intervention and the building having the building style of the building(s) within a threshold distance to the proposed building location.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a diagram illustrating a system for data-driven urban interventions based on crowdsourcing according to an embodiment of the present invention.

FIG. 2 is a flow diagram illustrating a method for data-driven urban interventions based on crowdsourcing according to an embodiment of the present invention.

FIG. 3 is a diagram illustrating an image database according to an embodiment of the present invention.

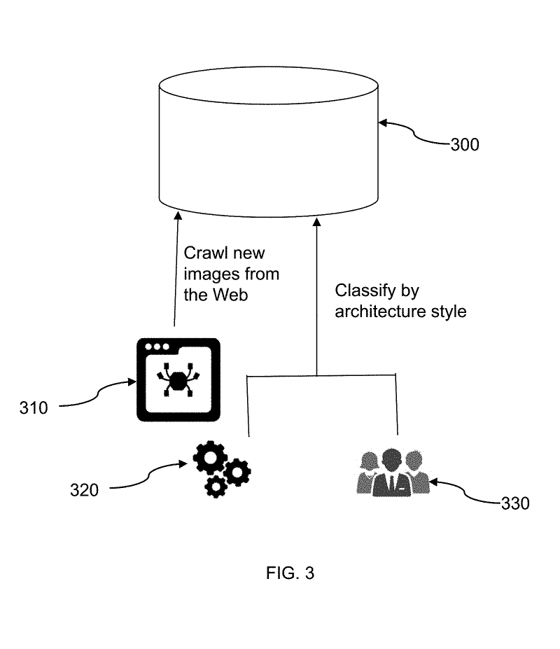

FIG. 4 is a diagram illustrating a citizen feedback database according to an embodiment of the present invention.

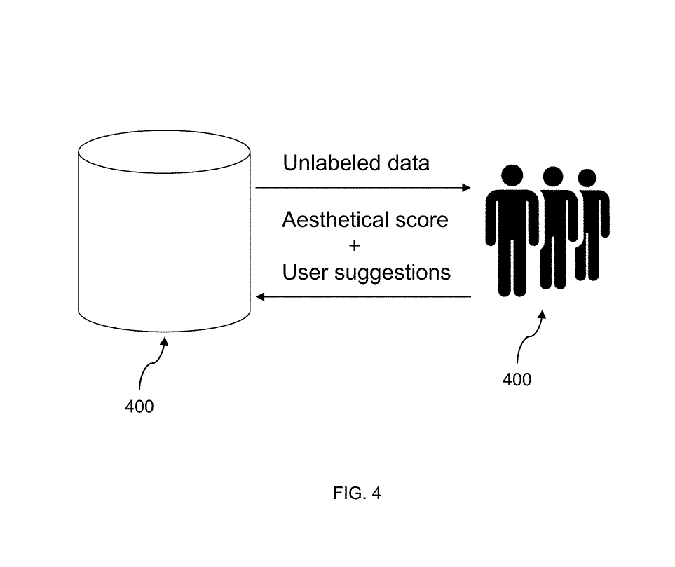

FIG. 5 is a diagram illustrating selection of a candidate building intervention according to an embodiment of the present invention.

FIG. 6 is a diagram illustrating a computer program product according to an embodiment of the present invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

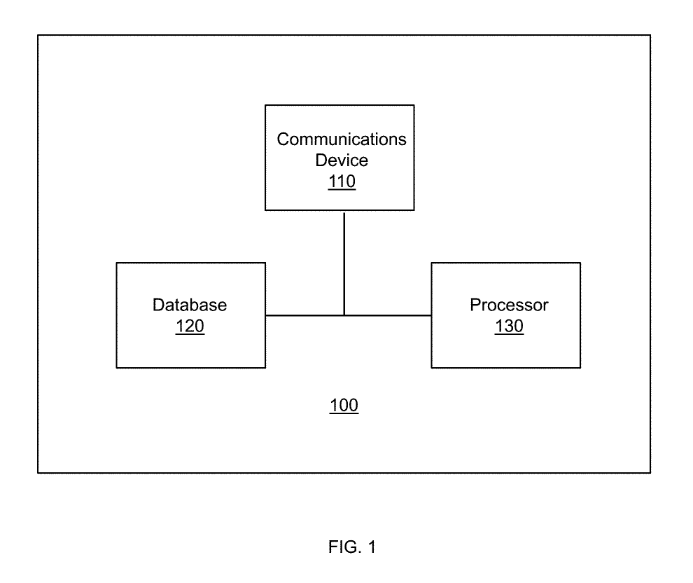

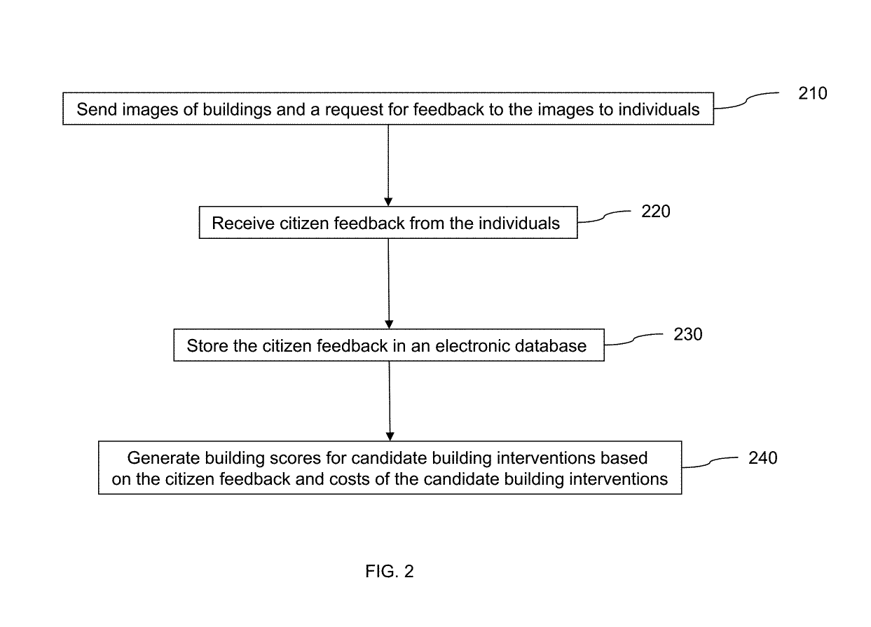

FIG. 1 is a diagram illustrating a system 100 for data-driven urban interventions based on crowdsourcing according to an embodiment of the present invention. The illustrated system 100 includes a communications device 110, an electronic database 120, and a processor 130. FIG. 2 is a flow diagram illustrating a method for data-driven urban interventions based on crowdsourcing (e.g., using the system 100) according to an embodiment of the present invention.

A communications device 110 can send images of buildings and a request for feedback to the images to individuals (210). As used herein, the term “communications device” includes a computer hardware device, such as, for example, a central processing unit (CPU), an integrated circuit, a microprocessor, an input port, an output port, and/or an antenna. As used herein, the term “buildings” refers to architectural structures that can include roofed and walled structure built for permanent use (as for a dwelling). Examples of buildings include office buildings, retail stores, apartment complexes, town homes, towers, gazebos, and monuments. An image database can be maintained by searching social media network(s) for images based on a keyword and/or a location (e.g., city, zip code, address, common name (e.g., ABC Square; XYZ Park). Images identified in the search can be uploaded into the image database.

In at least one embodiment, the communications device 110 receives citizen feedback from the individuals (220), where the citizen feedback includes a compatibility score indicating an aesthetical harmony between two or more buildings in the images and/or a building suggestion. For example, the compatibility score between Building A and Building B is 2.0 (the individual opines that the aesthetical harmony between Building A and Building B is low). In another example, the compatibility score between Building A and Building B is 8.5 (the individual opines that the aesthetical harmony between Building A and Building B is high). The building suggestion can include a suggestion to add a building having a specific architectural type (e.g., post-modern) to an area and/or a suggestion to remove a specific building from an area. The citizen feedback can be stored in an electronic database 120 that is connected to the communications device 110 (230). As used herein, the term “connected” includes operationally connected, logically connected, in communication with, physically or wirelessly connected, engaged, coupled, contacts, linked, affixed, and attached. In at least one embodiment, the electronic database 120 is the image database.

A processor 130 connected to the electronic database 120 can generate building scores for candidate building interventions based on the citizen feedback and costs of the candidate building interventions (240). As used herein, the term “interventions”, “building interventions”, or “candidate building interventions” refers to possible or proposed buildings to be built or modified on a building location. Each candidate building intervention of the building interventions can include a building style (e.g., post-medieval, Georgian, federal, revival, Italianate, second empire, Romanesque revival, gothic revival, Queen Anne, stick, shingle, exotic revival, colonial revival, Beaux arts Classicism, art deco, mid-century modernism, brutalism, etc.) and a building cost (actual or estimated cost of constructing the building).

The processor 130 can generate the building scores by generating a compatibility score for a candidate building intervention. More specifically, the processor 130 can identify the building style and the proposed building location of the candidate building intervention. For example, Building X has an art deco building style and a proposed building location of the corner of Main Street and 3rd Avenue. In at least one embodiment, the processor 130 identifies one or more buildings within a threshold distance (e.g., 100 meters) to the proposed building location using maps and online databases, as well as the building style(s) of the building(s) within the threshold distance to the proposed building location. For example, the processor 130 identifies that Building Y (art deco building style) and Building Z (contemporary building style) are within 100 meters of the proposed building location of Building X. When there are no buildings within the threshold distance to the proposed building location, the processor 130 can expand the threshold distance to an expanded threshold distance.

The processor 130 can analyze the electronic database 120 to determine the average compatibility score given to a combination of buildings having the building style of the candidate building intervention and a building having the building style of the at least one building within a threshold distance to the proposed building location. For example, because Building X has an art deco building style and Building Z has a contemporary building style, the processor 130 analyzes the electronic database 120 to determine the average compatibility score given to the combination of buildings with an art deco building style and buildings with a contemporary building style. For instance, if the electronic database 120 includes 100 compatibility scores for image(s) that include buildings with an art deco building style with buildings with a contemporary building style, then the processor 130 averages the 100 compatibility scores.

Continuing the above example, because Building X has an art deco building style and Building Y has an art deco building style, the processor 130 analyzes the electronic database 120 to determine the average compatibility score given to the combination of two or more buildings where each building has an art deco building style. In another embodiment, the processor 130 analyzes the electronic database 120 to determine the average compatibility score given to the candidate building intervention and each building that is within the threshold distance to the proposed building location. For example, the processor 130 analyzes the electronic database 120 to determine the average compatibility score given to the combination of Building X and Building Y by the individuals, and the average compatibility score given to the combination of Building X and Building Z by the individuals.

The processor 130 can set the average compatibility score as the compatibility score for the candidate building intervention. For example, the candidate building intervention is a building having Style ABC; and, the proposed building location is next to a building having Style XYZ. The citizen feedback indicates that buildings having Style ABC and buildings having Style XYZ have an average compatibility score of 8.3. This is the compatibility score.

In instances where there are multiple buildings within a threshold distance to the proposed building location, the processor 130 can average compatibility scores between the candidate building intervention and the multiple buildings. The processor 130 can set this average as the compatibility score for the candidate building intervention. For example, if the compatibility score between Building X and Building Y is 10.0 and the compatibility score between Building X and Building Z is 8.1, then the processor 130 sets the average compatibility score (9.1) as the compatibility score for the Building X.

In at least one embodiment of the invention, the processor 130 generates a budgeting factor for the candidate building intervention that indicates the degree that the candidate building intervention is the over budget for the proposed building location or the degree that the candidate building intervention is under the budget for the proposed building location. When the processor 130 generates the building scores, the processor 130 can multiply the compatibility score for the candidate building intervention by the budgeting factor. For example, a proposed building location has a budget of $1 million, Building X would cost $1.1 million to build, and Building X is given a budgeting factor of 0.95. The processor 130 can multiply the compatibility score of Building X (e.g., 9.1) by the budgeting factor (e.g., 0.95) to calculate the building score of Building X (e.g., 8.65).

In at least one embodiment of the invention, the processor 130 identifies one or more buildings within a threshold distance to a select building location (e.g., via maps, online databases) and the building style(s) of the identified building(s). For example, the processor 130 identifies that Building D is 5 meters from a select building location (e.g., 1234 Main Street) and that Building D has a federal building style. The processor 130 can analyze the citizen feedback in the electronic database 120 to identify a building style that has the highest average compatibility score with the building style of the identified building (excluding the building style of the identified building). For example, the processor 130 identifies that buildings have the Georgian building style has the highest average compatibility score Building D (excluding the federal building style). The processor 130 can output the identified building style to a user of the system 100 as a suggested building intervention.

The processor 130 can identify candidate building locations (123 1st Street, 456 8th Avenue, 789 Virginia Boulevard) for a select building intervention to be built (a new hotel having a mid-century modernism building style). For each candidate building location of the candidate building locations, the processor 130 can search for at least one building within a threshold distance (e.g., 10 meters) to the candidate building location (e.g., via maps, online databases). For example, the processor 130 locates 2 buildings proximate to 123 1st Street, 3 buildings proximate to 456 8th Avenue, and 5 buildings proximate to 789 Virginia Boulevard.

For each identified building, the processor 130 can analyze the electronic database 120 to identify the average compatibility score between the building style of the identified building and the building style of the select building intervention (e.g., the new hotel having the mid-century modernism building style). For example, Building E (brutalism building style) and Building F (Beaux arts classicism building style) are identified as being within 10 meters of 123 1st Street; and, the processor 130 identifies that the average compatibility score between buildings having a mid-century modernism building style (the new hotel to be built) and building having a brutalism building style (Building E) is 5.4, and the average compatibility score between buildings having a mid-century modernism building style (the new hotel to be built) and building having a Beaux arts classicism building style (Building F) is 3.6.

The processor 130 can identify the candidate building location of the candidate building locations having the highest average compatibility score with the building style of the select building intervention. For example, 123 1st Street has an average compatibility score of 4.5, 456 8th Avenue has an average compatibility score of 7.4, and 789 Virginia Boulevard has an average compatibility score of 6.8. The processor 130 can output the candidate building location having the highest average compatibility score (e.g., 456 8th Avenue) to a user of the system 100 as a suggested building location.

In another embodiment, the processor 130 identifies the candidate building location of the candidate building locations having the highest total compatibility score with the building style of the select building intervention. For example, 123 1st Street has a total compatibility score of 9.0, 456 8th Avenue has a total compatibility score of 22.2, and 789 Virginia Boulevard has a total compatibility score of 34. The processor 130 can output the candidate building location having the highest total compatibility score (e.g., 789 Virginia Boulevard) to a user of the system 100 as a suggested building location.

At least one embodiment of the invention provides a system that suggests one or more interventions that can make a city more harmonic while respecting a pre-defined maximum budget. In order to capture what is harmonic, the system may rely on subjective aesthetic judgments coming from citizens (crowdsourcing) and from a corpus of images that can be automatically classified by the same criteria. The system can also include other aspects besides aesthetical, such as the type of venue to be built (e.g., public garden, mall, etc.). The system can support urban planners on decisions about new constructions (e.g., suggesting the construction of new buildings) and/or can assist the city government by indicating areas that should be revitalized.

In at least one embodiment, the system suggests which interventions could be made in a city to make it more aesthetically harmonious using data from residents of the city and imaging from photographs of the city given a pre-defined maximum budget. The system can include an imaging database having images of the city labelled by region of the city and a description about the venues showed in the image. The system can include a web crawler to collect new images posted on social networking websites (e.g., Flickr, Instagram, Twitter) using keywords or geographic coordinates. The system can also include image processing algorithms to classify buildings in the images according to their architectural style. In another embodiment, building classification can be performed manually via user input into the imaging database.

The system can include a crowdsourcing module that sends images to individuals prompting their feedback about the architectonical style(s) depicted in the images. The crowdsourcing module can send a single image containing two or more buildings or a pair of images to individuals to receive feedback about combinations of architectonical styles. The crowdsourcing module can collect suggestions of buildings to be built or modified, including the location, style, size, etc. of the buildings.

The crowdsourcing module can receive the feedback and generate a score that represents the aesthetical harmony of the area shown in the images based on the user feedback. For example, the crowdsourcing module receives feedback from individual A that two building styles in a single image are highly harmonious, and generate a score of 10 out of 10. In another example, the crowdsourcing module receives feedback from individual B that a first building in a first image and a second building in a second image have styles that are highly contrasting, and generate a score of 1 out of 10.

In at least one embodiment of the invention, the system includes a budget-constrained intervention recommendation module that sets budgets for building interventions and/or assigns scores to building interventions based in part on the costs of the building interventions. Different interventions may be available for an area, and each intervention may have a different cost and a different resulting score. The budget-constrained intervention recommendation module can employ a Knapsack algorithm to choose building interventions that respects the budget limitations and maximizes the perception of improvement in the city, given by the utility of the improvement.

The algorithm can be used in an iterative manner. For example, several budgets values are pre-selected; and, for each budget, the algorithm is used to identify the highest aesthetical score that can be attained as a result of interventions made with the amount of money in the budget. In at least one embodiment, a systematic way of selecting budget values is delivered by a binary search algorithm, in which the initial lower bound is set to 0 and the initial upper bound is an arbitrary maximum value (e.g., maximum budget available for city interventions).

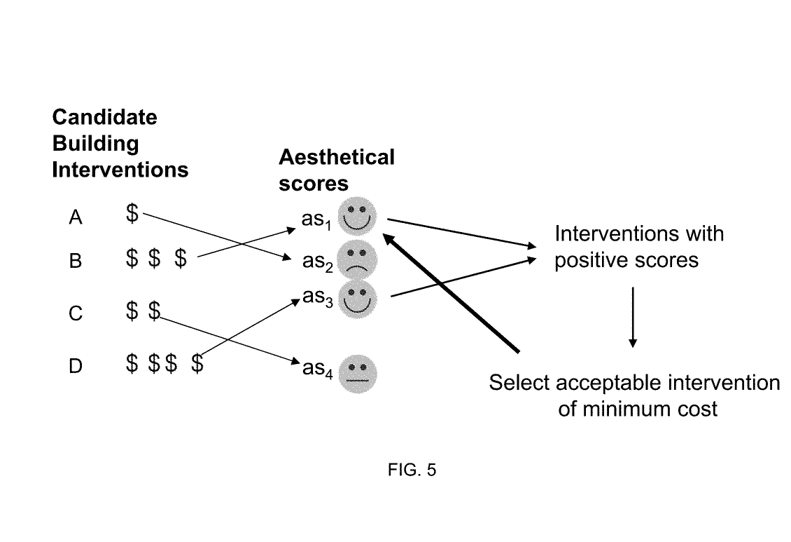

In at least one embodiment of the invention, the method is performed iteratively to select a minimum-cost set of interventions that yield a target aesthetical score. Several candidate building interventions are selected, and the cost (or estimated cost) of building each candidate building intervention is identified. For example, in FIG. 5, candidate building interventions A-D are selected.

The system can match the candidate building interventions with their respective aesthetical scores, which can be determined from the citizen feedback stored in the electronic database. For example, in FIG. 5, candidate building intervention A has a negative aesthetical score; candidate building intervention B has a positive aesthetical score; candidate building intervention C has a neutral aesthetical score; and, candidate building intervention D has a positive aesthetical score.

In the example illustrated in FIG. 5, the aesthetical scores are either positive (smiley face), negative (frown), or neutral (neither smiling or frowning). In another embodiment, the average aesthetical score (scale of 1-10) is determined from the citizen feedback in the electronic database. For example, the average compatibility score between the building location and buildings having the same style as candidate building intervention A is 2 out of 10.

In at least one embodiment of the invention, the system selects candidate building interventions using a binary search algorithm, in which the initial lower bound is set to zero (0) and the initial upper bound is an arbitrary maximum value (e.g., maximum budget available for city interventions). As illustrated in FIG. 5, candidate building interventions B and D are selected because they each have a positive aesthetical score. Candidate building intervention B can be selected over candidate building intervention D because candidate building intervention B has a lower building cost (i.e., $$$ versus $$$$).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

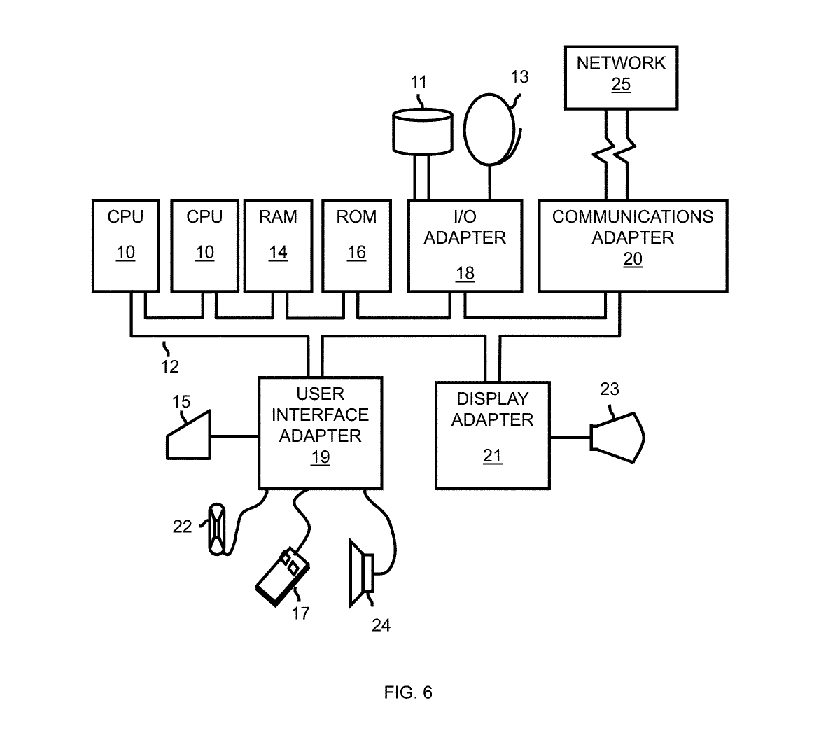

Referring now to FIG. 6, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 14, or other program storage devices that are readable by the system. The system can read the inventive instructions on the program storage devices and follow these instructions to execute the methodology of at least one embodiment of the invention. The system further includes a user interface adapter 14 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 24 which may be embodied as an output device such as a monitor, printer, or transmitter, for example.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for city planning, said method comprising:
sending images of buildings and a request for feedback to the images to individuals with a communications device;
receiving citizen feedback from the individuals with the communications device, the citizen feedback including a compatibility score indicating an aesthetical harmony between at least two buildings in the images;
storing the citizen feedback in an electronic database; and
generating building scores for candidate building interventions with a processor based on the citizen feedback and costs of the candidate building interventions, wherein each candidate building intervention includes a building style and a building cost.

2. The method according to claim 1, wherein said generating of the building scores includes generating a compatibility score for a candidate building intervention, said generating of the compatibility score for the candidate building intervention including:
identifying the building style of the candidate building intervention;
identifying a proposed building location of the candidate building intervention;
identifying at least one building within a threshold distance to the proposed building location;
identifying a building style of the at least one building within a threshold distance to the proposed building location; and
analyzing the electronic database to determine an average compatibility score given to a combination of buildings having the building style of the candidate building intervention and a building having the building style of the at least one building within a threshold distance to the proposed building location.

3. The method according to claim 2, expanding the threshold distance to an expanded threshold distance when there are no buildings within the threshold distance to the proposed building location.

4. The method according to claim 2, further comprising setting the average compatibility score as the compatibility score for the candidate building intervention.

5. The method according to claim 2, further comprising:
averaging compatibility scores between the candidate building intervention and multiple buildings within the threshold distance to the proposed building location when the proposed building location is within the threshold distance to multiple buildings; and
setting the average compatibility score between the candidate building intervention and the multiple buildings within the threshold distance to the proposed building location as the compatibility score for the candidate building intervention.

6. The method according to claim 2, further comprising generating a budgeting factor for the candidate building intervention, the budgeting factor indicating one of a degree that the candidate building intervention is over a budget for the proposed building location and a degree that the candidate building intervention is under the budget for the proposed building location,
wherein said generating of the building scores includes multiplying the compatibility score for the candidate building intervention by the budgeting factor.

7. The method according to claim 1, further comprising maintaining an image database, said maintaining of the image database including:
searching at least one social media network for images based on at least one of a keyword and a location;
uploading images identified in the search into the image database; and
classifying buildings in the images according to architectonic styles of the buildings in the images.

8. The method according to claim 1, further comprising:
identifying at least one building within a threshold distance to a select building location;
identifying a building style of the at least one building within the threshold distance to the select building location; and
analyzing the electronic database to identify a building style that has a highest average compatibility score with the building style of the at least one building within the threshold distance to the select building location.

9. The method according to claim 1, further comprising:
identifying candidate building locations for a select building intervention;
for each candidate building location, searching for at least one building within a threshold distance to the candidate building location; and
for each building identified in said searching for the at least one building within the threshold distance to the candidate building location, analyzing the electronic database to identify an average compatibility score between a building style of the identified building and a building style of the select building intervention.

10. The method according to claim 9, further comprising identifying a candidate building location having a highest total compatibility score with the building style of the select building intervention.

11. The method according to claim 9, further comprising identifying a candidate building location having a highest average compatibility score with the building style of the select building intervention.

12. A method for city planning, said method comprising:
sending images of buildings and a request for feedback to the images to individuals with a communications device;
receiving citizen feedback from the individuals with the communications device, the citizen feedback including a compatibility score indicating an aesthetical harmony between at least two buildings in the images and a building suggestion;
storing the citizen feedback in an electronic database; and
generating building scores for candidate building interventions with a processor based on the citizen feedback and costs of the candidate building interventions, wherein each candidate building intervention includes a building style and a building cost, said generating of the building scores includes generating a compatibility score for a candidate building intervention, said generating of the compatibility score for the candidate building intervention including:
identifying the building style of the candidate building intervention,
identifying a proposed building location for the candidate building intervention,
identifying at least one building within a threshold distance to the proposed building location,
identifying a building style of the at least one building within a threshold distance to the proposed building location, and
analyzing the electronic database to determine an average compatibility score given to a combination of buildings having the building style of the candidate building intervention and a building having the building style of the at least one building within a threshold distance to the proposed building location.

13. The method according to claim 12, expanding the threshold distance to an expanded threshold distance when there are no buildings within the threshold distance to the proposed building location.

14. The method according to claim 12, further comprising setting the average compatibility score as the compatibility score for the candidate building intervention.

15. The method according to claim 12, further comprising:
averaging compatibility scores between the candidate building intervention and multiple buildings within the threshold distance to the proposed building location when the proposed building location is within the threshold distance to multiple buildings; and
setting the average compatibility score between the candidate building intervention and the multiple buildings within the threshold distance to the proposed building location as the compatibility score for the candidate building intervention.

16. The method according to claim 12, further comprising generating a budgeting factor for the candidate building intervention, the budgeting factor indicating one of a degree that the candidate building intervention is over a budget for the proposed building location and a degree that the candidate building intervention is under the budget for the proposed building location,
wherein said generating of the building scores includes multiplying the compatibility score for the candidate building intervention by the budgeting factor.

17. The method according to claim 12, further comprising maintaining an image database, said maintaining of the image database including:
searching at least one social media network for images using a keyword and a location;
uploading images identified in the search into the image database; and
classifying buildings in the images according to architectonic styles of the buildings in the images.

18. The method according to claim 12, further comprising:
identifying at least one building within a threshold distance to a select building location;
identifying a building style of the at least one building within the threshold distance to the select building location; and
analyzing the electronic database to identify a building style that has a highest average compatibility score with the building style of the at least one building within the threshold distance to the select building location.

19. The method according to claim 12, further comprising:
identifying candidate building locations for a select building intervention;
for each candidate building location, searching for at least one building within a threshold distance to the candidate building location;
for each building identified in said searching for the at least one building within the threshold distance to the candidate building location, analyzing the electronic database to identify an average compatibility score between a building style of the identified building and a building style of the select building intervention;
identifying a candidate building location having a highest total compatibility score with the building style of the select building intervention; and
identifying a candidate building location having a highest average compatibility score with the building style of the select building intervention.

20. A computer program product for city planning, said computer program product comprising:
a computer readable storage medium having stored thereon:
first program instructions executable by a device to cause the device to send images of buildings and a request for feedback to the images to individuals with a communications device;
second program instructions executable by the device to cause the device to receive citizen feedback from the individuals with the communications device, the citizen feedback including at least one of a compatibility score indicating an aesthetical harmony between at least two buildings in the images and a building suggestion;
third program instructions executable by the device to cause the device to store the citizen feedback in an electronic database; and
fourth program instructions executable by the device to cause the device to generate building scores for candidate building interventions with a processor based on the citizen feedback and costs of the candidate building interventions, wherein each candidate building intervention includes a building style and a building cost.
